(19) United States
(12) Patent Application Publication
(10) Pub. No.: US 2018/0245930 A1
(43) Pub. Date: Aug. 30, 2018

(54) POWER CONSUMPTION DURING NAVIGATION VIA SMART SLEEP AND WAKE

(71) Applicant: INTERNATIONAL BUSINESS MACHINES CORPORATION, ARMONK, NY (US)

(72) Inventor: Kaleb Dean Walton, Fenton, MI (US)

(21) Appl. No.: 15/444,376

(22) Filed: Feb. 28, 2017

(51) Int. Cl. G01C 21/34; G01S 19/42

(52) U.S. Cl. CPC G01C 21/3415; G01S 19/42

(57) ABSTRACT

A method for navigation system power conservation is provided. The present invention may include receiving a travel route to a destination from a global positioning system, wherein the received travel route includes segments. The present invention may include, in response to determining a user has started traversing a segment, calculating a travel time for the segment. The present invention may include determining the calculated travel time exceeds a threshold. The present invention may include calculating a sleep time for the navigation system. The present invention may include executing a sleep mode for the navigation system. The present invention may include determining the user has taken a detour from the travel route based on monitoring a sensor. The present invention may include, in response to expiration of the calculated sleep time or determining the user has taken a detour, executing a navigation mode for the navigation system.

### BACKGROUND

The present invention relates, generally, to the field of computing, and more particularly to navigation systems.

Navigation systems aid a user in maneuvering a vehicle, such as an automobile, from a source to a destination. Typical navigation systems may be capable of anticipating traffic patterns en route to the predetermined destination as well as providing redirection when an alternate route becomes more efficient based on prevailing, external factors, such as weather or an automobile accident. Furthermore, navigation systems may be capable of calculating an estimated travel time for a specified route based on established speed limits, vehicle traffic, and collected user driving data, such as user average speed in relation to established speed limit.

### SUMMARY

According to one embodiment, a method, computer system, and computer program product for navigation system power conservation is provided. The present invention may include receiving a travel route to a destination from a global positioning system, whereby the received travel route includes a plurality of segments. The present invention may also include, in response to determining a user has started traversing a segment of the plurality of segments, calculating a travel time for the segment. The present invention may further include determining the calculated travel time exceeds a threshold. The present invention may also include calculating a sleep time for the navigation system. The present invention may further include executing a sleep mode for the navigation system. The present invention may also include determining the user has taken a detour from the travel route based on monitoring a sensor. The present invention may further include, in response to expiration of the calculated sleep time or determining the user has taken a detour, executing a navigation mode for the navigation system.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 is an operational flowchart illustrating a navigation power conservation process according to at least one embodiment;

FIG. 3 is a block diagram of internal and external components of computers and servers depicted in FIG. 1 according to at least one embodiment;

FIG. 4 depicts a cloud computing environment according to an embodiment of the present invention; and

FIG. 5 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to navigation systems. The following described exemplary embodiments provide a system, method, and program product to, among other things, utilize a power saving mode for a navigation system during long stretches of travel. Therefore, the present embodiment has the capacity to improve the technical field of navigation systems by reducing battery power consumption through the utilization of low power accelerometer and gyroscope inputs and a sleep timer to engage and disengage a navigation sleep mode when navigation may not be needed by the user.

As previously described, navigation systems aid a user in maneuvering a vehicle, such as an automobile, from a source to a destination. Typical navigation systems may be capable of anticipating traffic patterns en route to the predetermined destination as well as providing redirection when an alternate route becomes more efficient based on prevailing, external factors, such as weather or an automobile accident. Furthermore, navigation systems may be capable of calculating an estimated travel time for a specified route based on established speed limits, vehicle traffic, and collected user driving data, such as user average speed in relation to established speed limit.

Depending on the capabilities of installed applications, a device, such as a smartphone, may experience battery life issues when particular applications are operating. For example, a device executing ten applications concurrently may experience significantly reduced battery life since each application requires processing power to perform necessary functions. Furthermore, some applications, such as navigation applications, may require more processing power, and thus more quickly reduce a device's battery life, than other applications, such as a notetaking application.

When travelling, a user may need to utilize a navigation application as a means of guiding the user to a destination. However, the user may not have a device charging medium, such as a car charger or a portable battery charger. Therefore, the user may be required to ration the use of the navigation application in order to preserve the device's battery life sufficiently until the user reached the specified destination. For example, the user may only periodically open the navigation application after long stretches on a single road. Such rationing of application usage to preserve battery life may be both inconvenient and possibly dangerous for a user while operating a vehicle. As such, it may be advantageous to, among other things, use global positioning system data to calculate an estimated travel time on long stretches of a travel route so a power-conserving sleep mode for a navigation application may be utilized.

According to one embodiment, a navigation system that uses a global positioning system may experience improved battery efficiency but utilizing a sleep mode when a user begins a long stretch of a travel route. When the user begins a segment of a travel route that exceeds a travel time or travel distance threshold, the navigation application may calculate a sleep time for a period less than the expected travel time for the long stretch of the travel route and enter into a sleep mode. Once the sleep time has elapsed, the navigation application may resume standard operation and direct the user to the next segment of the travel route. In at least one embodiment, the navigation system may use low power input data from sensors, such as an accelerometer and a gyroscope, to determine whether the user has detoured from the travel route mapped by the navigation system before entering sleep mode. If a detour is detected, the navigation system may disengage the sleep mode before the expiration of the sleep time and resume standard operation.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to utilize a sleep mode for a navigation application when a user travels long segments of a predetermined travel route so as to conserve battery life of a user device.

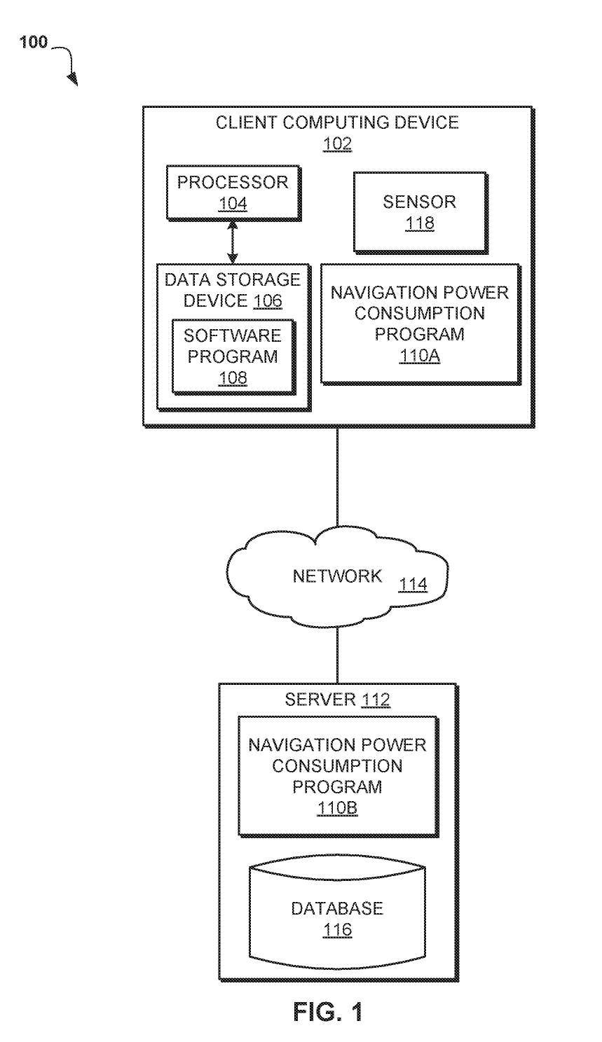

Referring to FIG. 1, an exemplary networked computer environment 100 is depicted, according to at least one embodiment. The networked computer environment 100 may include client computing device 102 and a server 112 interconnected via a communication network 114. According to at least one implementation, the networked computer environment 100 may include a plurality of client computing devices 102 and servers 112, of which only one of each is shown for illustrative brevity.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

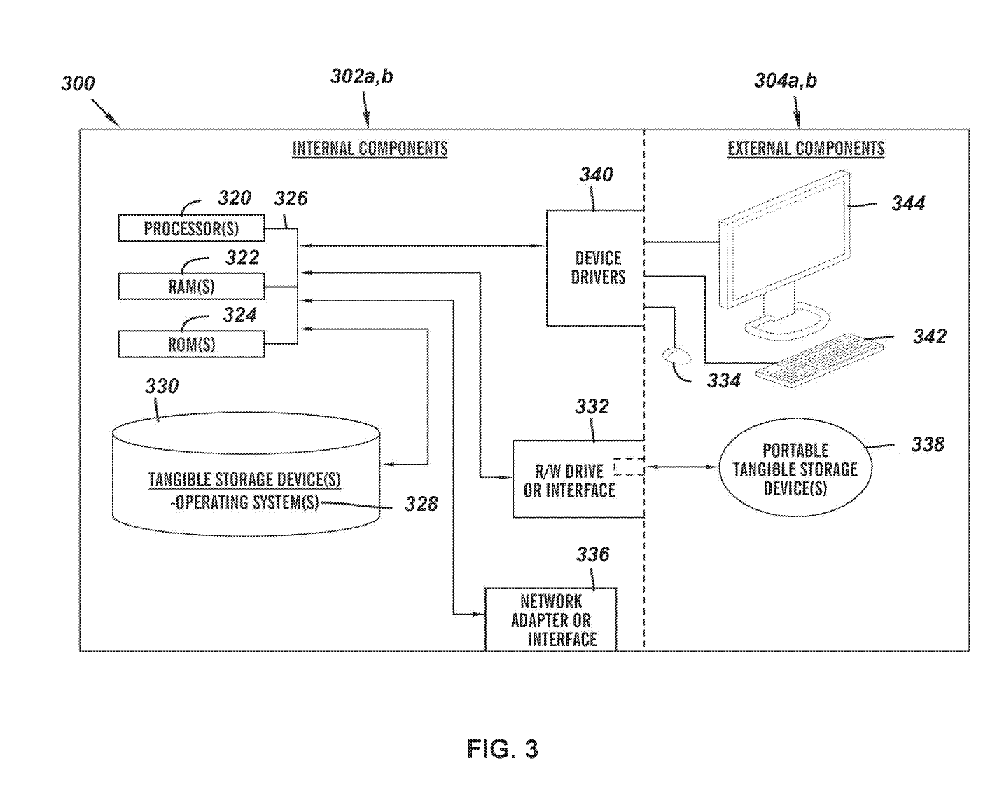

Client computing device 102 may include a processor 104, a data storage device 106, and a sensor 118 that is enabled to host and run a software program 108 and a navigation power conservation program 110A and communicate with the server 112 via the communication network 114, in accordance with one embodiment of the invention. Client computing device 102 may be, for example, a mobile device, a telephone, a personal digital assistant, a netbook, a laptop computer, a tablet computer, a desktop computer, or any type of computing device capable of running a program and accessing a network. As will be discussed with reference to FIG. 3, the client computing device 102 may include internal components 302a and external components 304a, respectively.

The server computer 112 may be a laptop computer, netbook computer, personal computer (PC), a desktop computer, or any programmable electronic device or any network of programmable electronic devices capable of hosting and running a navigation power conservation program 110B and a database 116 and communicating with the client computing device 102 via the communication network 114, in accordance with embodiments of the invention. As will be discussed with reference to FIG. 3, the server computer 112 may include internal components 302b and external components 304b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

According to the present embodiment, the sensor 118 may be a device capable of gathering environmental data to be utilized by the navigation power conservation program 110A, 110B to determine if the user detours from the predetermined travel route while the navigation power conservation program 110A, 110B is in sleep mode. The environmental data collected may include speed changes, acceleration changes, direction changes, lane changes, or any other data that may indicate the user has detoured from the travel route. The sensor 118 may include an accelerometer and a gyroscope. According to at least one implementation, the client computing device 102 may include a plurality of sensors 118, only one of which is shown for illustrative brevity. In various embodiments, the sensor 118 may internally installed in the client computing device 102 or externally connected to the client computing device 102.

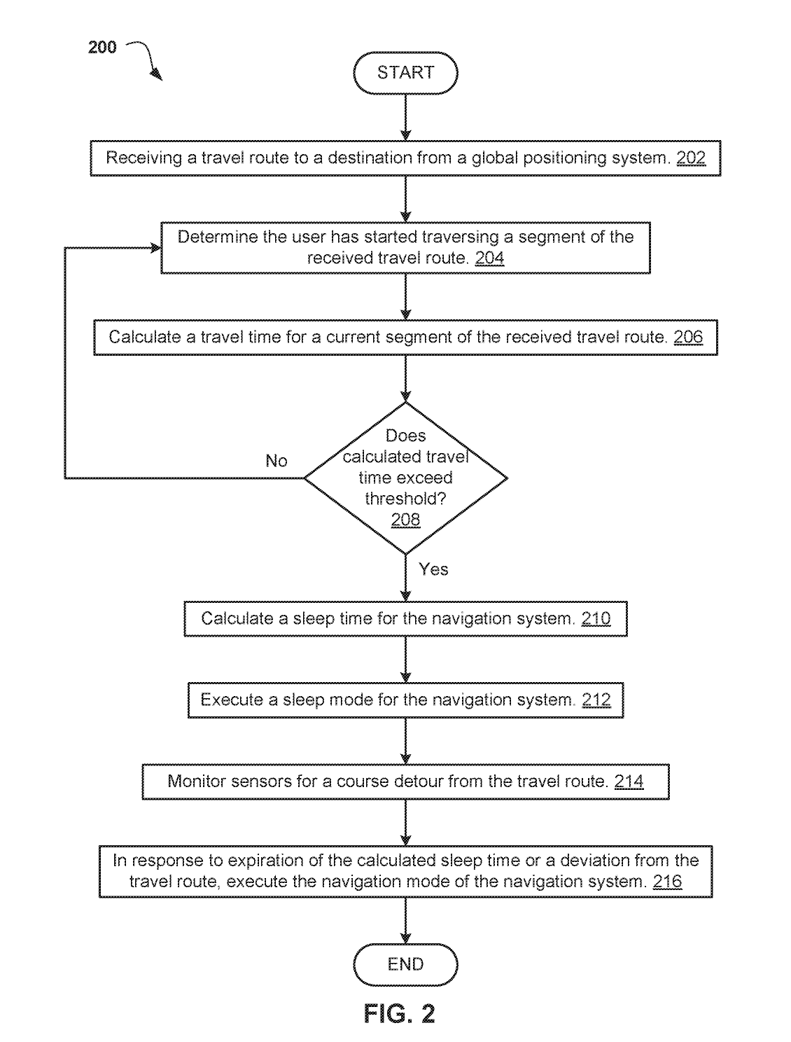

According to the present embodiment, the navigation power conservation program 110A, 110B may be a program capable of determining a travel route for a user to reach a desired destination, identifying when the user has begun a long segment of the determined travel route, calculating a sleep time for which the navigation power conservation program 110A, 110B will be in a power saving sleep mode, monitoring sensor data for user deviations from the determined travel route, and, upon the expiration of the sleep time or identifying a deviation from the travel route, disengaging the sleep mode and resuming standard operation. The navigation power conservation method is explained in further detail below with respect to FIG. 2.

Referring now to FIG. 2, an operational flowchart illustrating a navigation power conservation process 200 is depicted according to at least one embodiment. At 202, the navigation power conservation program 110A, 110B receives a travel route to a destination from a global positioning system. The travel route may be a series of individual segments that lead a user to a preconfigured destination. When the user initiates a global positioning system as a navigation aid, the user may be required to designate a destination towards which the navigation system may direct the user. Once a user configures a destination in the navigation system, the navigation system, via the global positioning system, may create a travel route on which the user may be directed to travel. The navigation power conservation program 110A, 110B may receive the travel route from the global positioning system so that the navigation power conservation program 110A, 110B may monitor user progress along the travel route. In at least one embodiment, the travel route may be traversed via various travel methods, such as an automobile, a bicycle, or pedestrian travel.

Then, at 204, the navigation power conservation program 110A, 110B determines the user has started traversing a segment of the received travel route. When a user first starts a segment of the travel route, the navigation power conservation program 110A, 110B may calculate a travel time for the newly started segment. Therefore, the navigation power conservation program 110A, 110B may communicate with the navigation system to monitor the user progress through the travel route in order to determine when the user has started a new segment of the travel route.

Next, at 206, the navigation power conservation program 110A, 110B calculates a travel time to traverse a current segment of the travel route. At the commencement of each segment of the travel route, the navigation power conservation program 110A, 110B may calculate an estimated travel time for the user to traverse the current segment using known algorithms and/or formulas. For example, the navigation power conservation program 110A, 110B may determine that a five mile segment of highway driving may require an average of five minutes for the user to traverse traveling 60 miles per hour. In at least one embodiment, the navigation power conservation program 110A, 110B may calculate the travel time for each segment of the travel route when the travel route is received by the navigation power conservation program 110A, 110B from the global positioning system rather than at the commencement of each segment.

Then, at 208, the navigation power conservation program 110A, 110B determines whether the calculated travel time exceeds a threshold. According to one implementation, the navigation power conservation process 200 may continue along the operation flowchart, if the calculated travel time exceeds a threshold. The threshold may be a user preconfigured value that defines a segment of the travel route for which the navigation power conservation program 110A, 110B may initiate a sleep mode for the navigation system. For example, if the threshold is configured at 10 minutes, the navigation power conservation program 110A, 110B may determine the threshold has been exceeded when a recently started segment of the travel route is estimated to take 15 minutes to traverse. Therefore, the navigation power conservation program 110A, 110B may initiate a sleep mode for the navigation system during the current segment of the travel route to conserve battery power. If the navigation power conservation program 110A, 110B determines the calculated travel time does exceed a threshold (step 208, “Yes” branch), the navigation power conservation process 200 may continue to step 210 to calculate a sleep time for the navigation system. If the navigation power conservation program 110A, 110B (FIG. 1) determines the calculated travel time does not exceed a threshold (step 208, “No” branch), the navigation power conservation process 200 may return to step 204 to monitor the travel route and determine the user has started traversing a new travel route segment.

Then, at 210, the navigation power conservation program 110A, 110B calculates a sleep time for the navigation system. The sleep time calculated by the navigation power conservation program 110A, 110B may be based on a preconfigured percentage of the calculated travel time for the current segment of the travel route. For example, if the calculated travel time of the current segment of the travel route that exceeds the preconfigured threshold is 20 minutes and the sleep time is calculated as 75% of the calculated travel time, the navigation power conservation program 110A, 110B may calculate the total sleep time in which to place the navigation system as 15 minutes.

Next, at 212, the navigation power conservation program 110A, 110B executes a sleep mode for the navigation system. Once a sleep time has been calculated, the navigation power conservation program 110A, 110B may execute a sleep mode for the navigation system by transmitting a command to the navigation system to enter a sleep mode. Additionally, the navigation power conservation program 110A, 110B may utilize a timer set to the calculated sleep time in order to determine when the sleep mode for the navigation system should be disengaged and normal navigation operations should be reengaged.

Then, at 214, the navigation power conservation program 110A, 110B monitors sensors 118 for a course detour from the travel route. When the navigation system is in sleep mode, the navigation power conservation program 110A, 110B may have access to environmental data gathered by the sensor 118. As previously described, sensor 118 may be a device, such as a gyroscope or an accelerometer, capable of gathering environmental data to be utilized by the navigation power conservation program 110A, 110B to determine if the user detours from the predetermined travel route while the navigation power conservation program 110A, 110B is in sleep mode. Also as previously described, the environmental data collected may include speed changes, acceleration changes, direction changes, lane changes, or any other data that may indicate the user has detoured from the travel route. The navigation power conservation program 110A, 110B may utilize known machine learning algorithms analyze the environmental data to determine the user has made a detour from the travel route. Additionally, a detour from the travel route may be any number of actions that change or alter the user's course or travel time, such as a slowdown, a stop, a turn, an exit from a highway, a movement from a vehicle, and a movement into a vehicle

Next, at 216, the navigation power conservation program 110A, 110B, in response to expiration of the calculated sleep time or a course detour from the travel route, engages the navigation mode of the navigation system. When the calculated sleep timer expires, the navigation power conservation program 110A, 110B may determine that the navigation system sleep mode should be disengaged. For example, if the sleep time for a segment of the travel route was calculated as 15 minutes, the navigation power conservation program 110A, 110B may disengage the navigation system sleep mode once the user has traveled on the segment for 15 minutes. Similarly, if the navigation power conservation program 110A, 110B determines that the user has detoured from the travel route based on the environmental data gathered by the sensor 118, the navigation power conservation program 110A, 110B may also determine the navigation system sleep mode should be disengaged. For example, if the navigation power conservation program 110A, 110B determines the user exited a highway after 5 minutes of a calculated 20 minute segment travel time, the navigation power conservation program 110A, 110B may disengage the navigation system sleep mode and reengage the navigation mode since the user detoured from the expected travel route.

It may be appreciated that FIG. 2 provides only an illustration of one implementation and does not imply any limitations with regard to how different embodiments may be implemented. Many modifications to the depicted environments may be made based on design and implementation requirements.

FIG. 3 is a block diagram 300 of internal and external components of the client computing device 102 and the server 112 depicted in FIG. 1 in accordance with an embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

The data processing system 302, 304 is representative of any electronic device capable of executing machine-readable program instructions. The data processing system 302, 304 may be representative of a smart phone, a computer system, PDA, or other electronic devices. Examples of computing systems, environments, and/or configurations that may represented by the data processing system 302, 304 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 302a,b and external components 304a,b illustrated in FIG. 3. Each of the sets of internal components 302 include one or more processors 320, one or more computer-readable RAMs 322, and one or more computer-readable ROMs 324 on one or more buses 326, and one or more operating systems 328 and one or more computer-readable tangible storage devices 330. The one or more operating systems 328, the software program 108 and the navigation power conservation program 110A in the client computing device 102 and the navigation power conservation program 110B in the server 112 are stored on one or more of the respective computer-readable tangible storage devices 330 for execution by one or more of the respective processors 320 via one or more of the respective RAMs 322 (which typically include cache memory). In the embodiment illustrated in FIG. 3, each of the computer-readable tangible storage devices 330 is a magnetic disk storage device of an internal hard drive. Alternatively, each of the computer-readable tangible storage devices 330 is a semiconductor storage device such as ROM 324, EPROM, flash memory or any other computer-readable tangible storage device that can store a computer program and digital information.

Each set of internal components 302a,b also includes a R/W drive or interface 332 to read from and write to one or more portable computer-readable tangible storage devices 338 such as a CD-ROM, DVD, memory stick, magnetic tape, magnetic disk, optical disk or semiconductor storage device. A software program, such as the navigation power conservation program 110A, 110B, can be stored on one or more of the respective portable computer-readable tangible storage devices 338, read via the respective R/W drive or interface 332, and loaded into the respective hard drive 330.

Each set of internal components 302a,b also includes network adapters or interfaces 336 such as a TCP/IP adapter cards, wireless Wi-Fi interface cards, or 3G or 4G wireless interface cards or other wired or wireless communication links. The software program 108 and the navigation power conservation program 110A in the client computing device 102 and the navigation power conservation program 110B in the server 112 can be downloaded to the client computing device 102 and the server 112 from an external computer via a network (for example, the Internet, a local area network or other, wide area network) and respective network adapters or interfaces 336. From the network adapters or interfaces 336, the software program 108 and the navigation power conservation program 110A in the client computing device 102 and the navigation power conservation program 110B in the server 112 are loaded into the respective hard drive 330. The network may comprise copper wires, optical fibers, wireless transmission, routers, firewalls, switches, gateway computers and/or edge servers.

Each of the sets of external components 304a,b can include a computer display monitor 344, a keyboard 342, and a computer mouse 334. External components 304a,b can also include touch screens, virtual keyboards, touch pads, pointing devices, and other human interface devices. Each of the sets of internal components 302a,b also includes device drivers 340 to interface to computer display monitor 344, keyboard 342, and computer mouse 334. The device drivers 340, R/W drive or interface 332, and network adapter or interface 336 comprise hardware and software (stored in storage device 330 and/or ROM 324).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

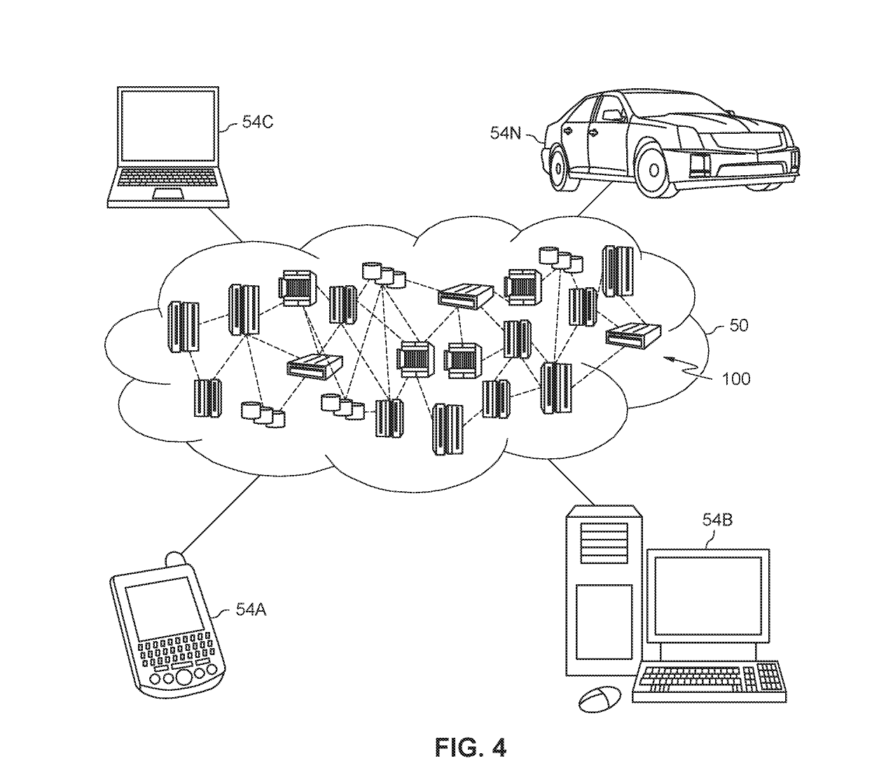

Referring now to FIG. 4, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 100 and cloud computing environment 50 can communicate with any type of computerized device over any type of network and/or network addressable connection (e.g., using a web browser).

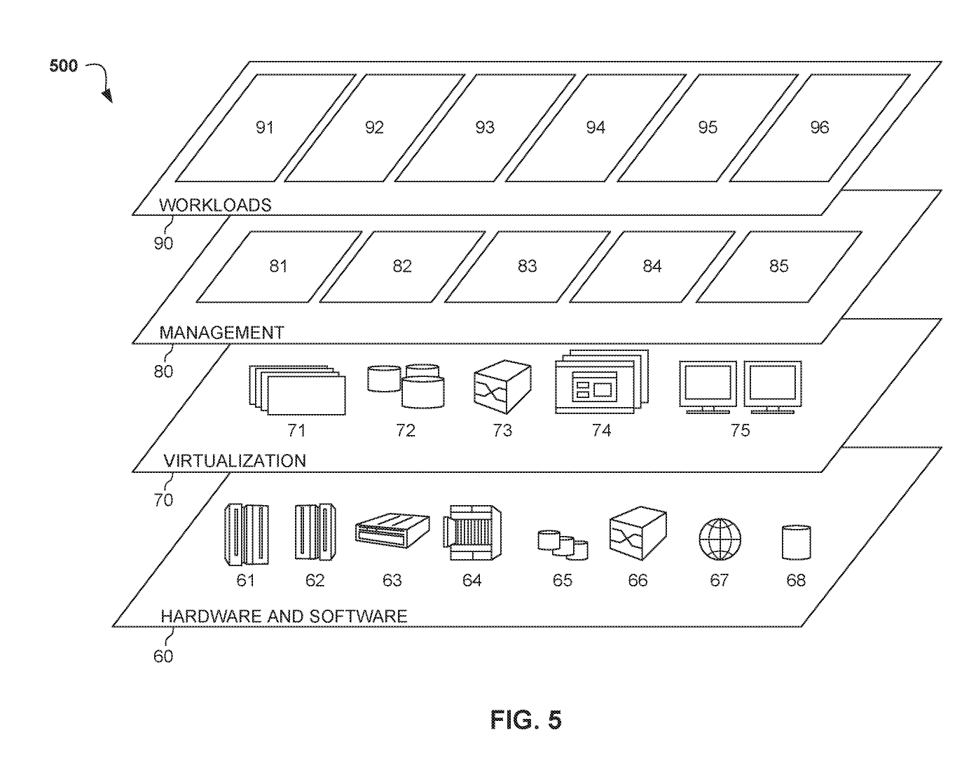

Referring now to FIG. 5, a set of functional abstraction layers 500 provided by cloud computing environment 50 is shown. It should be understood in advance that the components, layers, and functions shown in FIG. 4 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and navigation power conservation 96. Navigation power conservation 96 may relate to determining that a user traversing a travel route has reached a segment that exceeds a threshold time to traverse and engages a navigation system sleep mode for a preconfigured period of time. Additionally, navigation power conservation 96 may relate to monitoring environmental data corresponding to the user traversing the travel route while the navigation system in engaged in a sleep mode to determine if the user detours from the established travel route in order to disengage the sleep mode and resume standard navigation functions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for navigation system power conservation, the method comprising:
receiving, by a processor, a travel route to a destination from a global positioning system, wherein the received travel route includes a plurality of segments;
in response to determining a user has started traversing a segment of the plurality of segments, calculating a travel time for the segment;
determining the calculated travel time exceeds a threshold;
calculating a sleep time for the navigation system;
executing a sleep mode for the navigation system;
determining the user has taken a detour from the travel route based on monitoring a sensor; and
in response to expiration of the calculated sleep time or determining the user has taken a detour, executing a navigation mode for the navigation system.

2. The method of claim 1, wherein the sleep time is calculated as a user preconfigured percentage of the calculated travel time.

3. The method of claim 1, wherein the detour is selected from a group consisting of a slowdown, a stop, a turn, an exit from a highway, a movement from a vehicle, and a movement into a vehicle.

4. The method of claim 1, wherein the sensor is selected from a group consisting of a gyroscope and an accelerometer.

5. The method of claim 1, wherein the sensor gathers a plurality of environmental data.

6. The method of claim 5, wherein the plurality of environmental data is selected from a group consisting of a speed change, an acceleration change, a direction change, and a lane change.

7. The method of claim 1, wherein the user traverses the travel route via a travel method, and wherein the travel method is selected from a group consisting of an automobile, a bicycle, and pedestrian travel.

8. A computer system for navigation system power conservation, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
receiving a travel route to a destination from a global positioning system, wherein the received travel route includes a plurality of segments;
in response to determining a user has started traversing a segment of the plurality of segments, calculating a travel time for the segment;
determining the calculated travel time exceeds a threshold;
calculating a sleep time for the navigation system;
executing a sleep mode for the navigation system;
determining the user has taken a detour from the travel route based on monitoring a sensor; and
in response to expiration of the calculated sleep time or determining the user has taken a detour, executing a navigation mode for the navigation system.

9. The computer system of claim 8, wherein the sleep time is calculated as a user preconfigured percentage of the calculated travel time.

10. The computer system of claim 8, wherein the detour is selected from a group consisting of a slowdown, a stop, a turn, an exit from a highway, a movement from a vehicle, and a movement into a vehicle.

11. The computer system of claim 8, wherein the sensor is selected from a group consisting of a gyroscope and an accelerometer.

12. The computer system of claim 8, wherein the sensor gathers a plurality of environmental data.

13. The method of claim 12, wherein the plurality of environmental data is selected from a group consisting of a speed change, an acceleration change, a direction change, and a lane change.

14. The method of claim 8, wherein the user traverses the travel route via a travel method, and wherein the travel method is selected from a group consisting of an automobile, a bicycle, and pedestrian travel.

15. A computer program product for navigation system power conservation, the computer program product comprising:
one or more computer-readable tangible storage medium and program instructions stored on at least one of the one or more tangible storage medium, the program instructions executable by a processor, the program instructions comprising:
program instructions to receive a travel route to a destination from a global positioning system, wherein the received travel route includes a plurality of segments;
in response to determining a user has started traversing a segment of the plurality of segments, program instructions to calculate a travel time for the segment;
program instructions to determine the calculated travel time exceeds a threshold;
program instructions to calculate a sleep time for the navigation system;
program instructions to execute a sleep mode for the navigation system;
program instructions to determine the user has taken a detour from the travel route based on monitoring a sensor; and
in response to expiration of the calculated sleep time or determining the user has taken a detour, program instructions to execute a navigation mode for the navigation system.

16. The computer program product of claim 15, wherein the sleep time is calculated as a user preconfigured percentage of the calculated travel time.

17. The computer program product of claim 15, wherein the detour is selected from a group consisting of a slowdown, a stop, a turn, an exit from a highway, a movement from a vehicle, and a movement into a vehicle.

18. The computer program product of claim 15, wherein the sensor is selected from a group consisting of a gyroscope and an accelerometer.

19. The computer program product of claim 15, wherein the sensor gathers a plurality of environmental data.

20. The computer program product of claim 19, wherein the plurality of environmental data is selected from a group consisting of a speed change, an acceleration change, a direction change, and a lane change.
